(19) United States
(12) Patent Application Publication
(10) Pub. No.: US 2026/0283399 A1
(43) Pub. Date: Sep. 24, 2026

(54) AUTOMATED BROILER AND METHOD OF USE

(71) Applicant: J & J Innovations, LLC, Mankato, MN (US)

(72) Inventor: John Massad, Mankato, MN (US)

(21) Appl. No.: 19/478,607

(22) PCT Filed: Apr. 11, 2024
(86) PCT No.: PCT/US2024/023999

§ 371 Date: Oct. 24, 2025

Related U.S. Application Data
(60) Provisional application No. 63/498,375, filed on Apr. 26, 2023.

(51) Int. Cl. A47J 37/04

(52) U.S. Cl. CPC A47J 37/043

(57) ABSTRACT

A broiler includes a broiling structure having a support structure configured to carry heating elements and to accept a skewer of stacked raw meat. The broiling structure includes a first linear bearing attached to the support structure and configured to move the support structure in a first linear movement, and a first linear actuator coupled to the first linear bearing, wherein the first linear actuator is configured to move the support structure along the first linear bearing. The broiler includes a cutting mechanism having a cutting component carrying a blade and a non-touch temperature sensor. The cutting mechanism includes a second linear bearing attached to the cutting component and configured to move the cutting component in a second linear movement that is substantially orthogonal to the first linear movement. A second linear actuator is coupled to the second linear bearing, wherein the second linear actuator is configured to move the cutting component along the second linear bearing.

### BACKGROUND

The present disclosure relates a broiler for cooking meat or other foodstuffs on rotating skewer. More particularly, the present disclosure relates to an automated broiler that cooks a stack of meat or other foodstuffs retained on a rotating skewer or spigot that travels past a radiant heat source, determines the surface temperature of the meat and cuts the cooked meat from the perimeter of the stacked meat without the need of human assistance.

Typically, the cooking of meat on a rotating skewer with a vertical broiler is labor intensive and knowledge based, where the cooking is based upon experience using the vertical broiler and the type of meat being cooked. The cook uses his/her experience and knowledge to determine when the perimeter portion of the meat is cooked and the depth around the perimeter that is ready to be cut from the rotating skewer. For instance, the cook knows that the perimeter of the meat is cooked based upon the look of the meat on the perimeter and then cuts the meat to a depth that is known to be cooked.

As the cooking of the meat is based upon the cooking characteristics of the vertical broiler and the meat being cooked, when a cook leaves that knowledge is lost. This requires the owner of the restaurant to train additional cooks, who again need time to gain the knowledge of the characteristics of the vertical broiler and when the meat is cooked safely and ready to be cut. Having to train the new cooks is typically quite costly in time and potentially revenue to the restaurant owner.

Additionally, the cooking of meat on a vertical broiler on a rotating skewer can pose health safety risks if the meat is not cooked to a safe temperature. For instance, when cooking gyro meat, such a mixture of lamb and/or beef, the meat is typically less likely to include food borne pathogens relative to other meats, such as chicken used to cook chicken schwarma. When cooking red gyro meat, the meat can be cooked beyond the rare stage, which can ensure that if pathogens are in the meat, the pathogens are destroyed. However, when cooking chicken, such as chicken schwarma, the cook must balance cooking the chicken to a temperature that destroys pathogens, while not overcooking the chicken which causes the chicken to dry out.

There is a need to automate the cooking process of cooking a stack of meat or other foodstuff on a rotating skewer or spigot in a broiler that eliminates or substantially reduces the need for reliance on human intervention. Additionally, there is a need to automate the cooking and cutting process to substantially eliminate the risk of serving undercooked meat to diners.

### SUMMARY

One aspect of the present disclosure relates to a broiler that includes a broiling structure having a support structure configured to carry heating elements and to accept a skewer or spigot of stacked raw meat or other foodstuff. The broiling structure includes a first linear bearing attached to the support structure and configured to move the support structure in a first linear movement, and a first linear actuator coupled to the first linear bearing, wherein the first linear actuator is configured to move the support structure along the first linear bearing. The broiler includes a cutting mechanism having a cutting component carrying a blade and a non-touch temperature sensor. The cutting mechanism includes a second linear bearing attached to the cutting component and configured to move the cutting component in a second linear movement that is substantially orthogonal to the first linear movement, and a second linear actuator coupled to the second linear bearing, wherein the second linear actuator is configured to move the cutting component along the second linear bearing. The broiler includes a controller configured to activate the heating elements, cause the skewer or spigot and stacked raw meat or other foodstuff to rotate past the heating elements and monitor a surface temperature of the meat during the cooking process such that the cooking process continues until the surface temperature meets or exceeds a setpoint. After the surface temperature reaches or exceeds the setpoint, the controller causes the cooking process to cease, causes the stacked meat to be mapped for slicing, and causes a cooked outer portion of the meat to be cut from the perimeter without the need of human intervention.

Another aspect of the present disclosure relates to a method of automatically cooking and slicing meat from a stack of meat in a broiler. The method included providing the broiler with a substantially uniform broiling structure. The broiler structure includes a support structure configured to carry heating elements and to accept a skewer or spigot of stacked raw meat, a first linear bearing attached to the support structure and configured to move the support structure in a first linear direction, and a first linear actuator coupled to the first linear bearing, wherein the first linear actuator is configured to move the support structure along the first linear bearing. The broiler further includes a cutting mechanism having a cutting component carrying a blade and a non-contact temperature sensor, a second linear bearing attached to the cutting component and configured to move the cutting component in a second linear movement that is substantially orthogonal to the first linear movement; and a second linear actuator coupled to the second linear bearing, wherein the second linear actuator is configured to move the cutting component along the second linear bearing. The method includes placing the skewer or spigot with stacked meat into the broiler, rotating the skewer or spigot of stacked meat about an axis of the skewer or spigot and energizing heating elements. The method further includes monitoring a surface temperature through the heating process with a non-contact temperature sensor in real time and stopping the cooking process after the surface temperature reaches a predetermined setpoint.

### BRIEF DESCRIPTION OF THE DRAWINGS

FIG. 1 is a perspective view of an automated vertical broiler.

FIG. 2 is another perspective view of the automated vertical broiler.

FIG. 3 is a perspective view of internal components of the automated vertical broiler.

FIG. 4 is a perspective view of a portion of the automated broiler components

FIG. 5 is another perspective view of another portion of the automated broiler components.

FIG. 6 is a sectional view taken along section line 6-6 in FIG. 3.

FIG. 7 is a sectional view taken along section line 7-7 in FIG. 3.

FIG. 8 is a perspective view of cutting components of the automated vertical broiler.

FIG. 9 is another perspective view of cutting components of the automated vertical broiler.

FIG. 10 is a sectional view taken along section line 10-10 in FIG. 3.

FIG. 11 is a flow chart of a method of initiating an automated cooking process.

FIG. 12 is flow chart of a method for mapping a meat stack for automated slicing.

FIG. 13 is a flow chart of a method for automatically slicing meat from about a perimeter of the meat stack.

### DETAILED DESCRIPTION

The present disclosure relates to an automated vertical broiler that cooks meat on a rotating skewer, monitors the surface temperature of the meat on the rotating skewer in real time and after the meat about the perimeter is cooked, the automated vertical broiler cuts the meat from a perimeter of the rotating meat into slices with precise thicknesses. The automated vertical broiler substantially eliminates the need for a cook, the cook's learned knowledge about the characteristics of the vertical broiler and the meat and the labor costs associated with cooking and cutting the meat. The automated vertical broiler also substantially increases uniformity in the quality, the temperature of the cooked and sliced meat and the sliced meat thickness, while substantially reducing and/or eliminating the likelihood of serving undercooked meat.

While a vertical broiler is disclosed and described herein, the broiler can be in any suitable orientation from rotating the stack of meat along a horizontal axis to any angled axis between horizontal and vertical. While the present disclosure relates to cooking a stack of meat on a rotating skewer, the present broiler can used to cook any suitable foodstuff and is not limited to the cooking of meat.

The automated vertical broiler of the present disclosure includes a vertical broiling structure that carries the stacked meat on a rotatable skewer or spigot past heating elements. In the present application, skewer and spigot are used interchangeably.

The vertical broiling structure moves along a single linear bearing by actuating a linear actuator in a substantially horizontal direction toward and away from a cutting mechanism. The single linear bearing and the single actuator allows for movement of the broiling structure in the horizontal direction while substantially preventing vertical, rotational and/or twisting movement of the broiling structure. Additionally, the single actuator allows the location of the broiling structure in the horizontal direction to be known at all times during the cooking and slicing process.

Utilizing a single actuator allows for the smooth and reliable horizontal movement of the vertical broiling structure towards and away from a cutting mechanism. It has been found that when two or more actuators are utilized and the movements of the actuators are not synchronized, the actuators can cause binding and/or non-uniform movement of the broiling structure, which can adversely affect the reliability of the vertical broiler and also adversely affect quality of the cooked and cut meat.

The cutting mechanism of the vertical broiler moves in a substantially vertical motion on a linear bearing actuated by a linear actuator. The cutting mechanism includes an automated cutting blade, whether a rotating blade or an oscillating blade, a temperature sensor, and a shield that substantially prevents the spatter generated during the cutting process from adversely affecting the temperature sensor. The temperature sensor senses the perimeter temperature of the stacked meat such that once the perimeter reaches a consistent temperature setpoint indicative of the meat being sufficiently cooked, the cutting mechanism in combination with the broiling structure is used to cut the meat in slices from the perimeter of the stack of meat without the need for human interaction.

### The Automatic Vertical Broiler

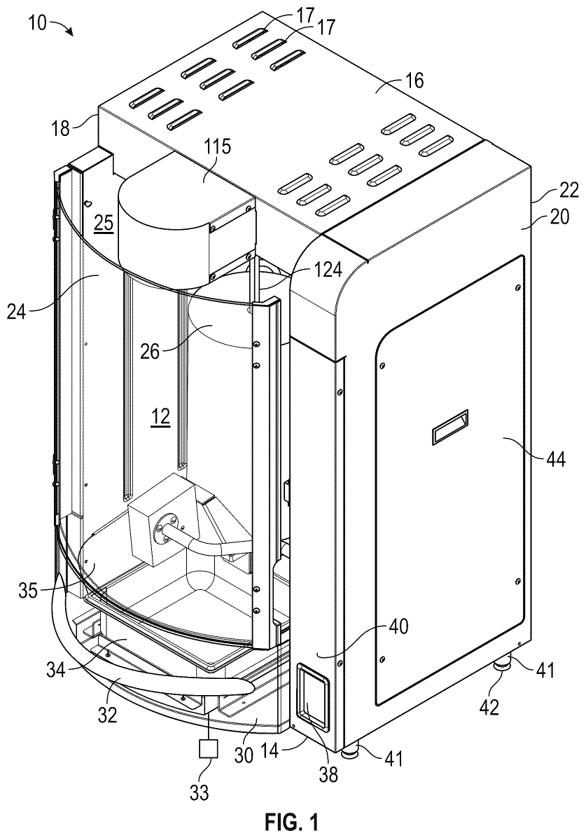

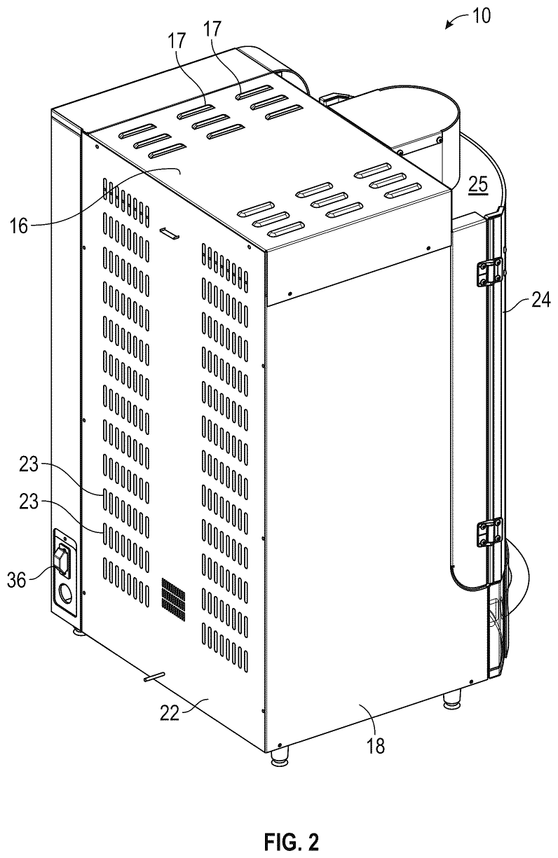

Referring to FIGS. 1 and 2, an automated vertical broiler is illustrated at 10. The automated vertical broiler 10 includes a chamber 12 defined by a bottom wall 14, a top wall 16, a left wall 18, a right wall 20 and back wall 22. The automated vertical broiler 10 includes a hinged door 24 that provides access to the heat chamber 12 such that a stack of meat 26 on a skewer 124 can be loaded into the chamber 12 for cooking. The hinged door 24 is arcuate in configuration and is constructed of an optically transparent material, such as glass, or an optically translucent material such that that the cooking and cutting process can be occasionally visually monitored through the door 24.

The automated vertical broiler 10 includes a drawer 30 with a removable tray 34 that is configured to receive slices of meat cut from the stack of meat 26. The broiler 10 includes a left deflector panel 35 removably attached to the left wall 18 and a right deflector panel 37 removably attached to the right wall 20. The deflector panels 35 and 37 are angled from the walls 18 and 20 toward the tray 34 such that the falling sliced meat engages the deflector panels 35 and 37 and lands in the tray 34 and not on the drawer 30 outside of the tray 37.

After a selected number of slices are cut from the stack, the control panel 38 displays a message that the tray 34 should be emptied. In another embodiment, a sensor 33, such as a load cell, determines when the tray 34 is full, such that the sliced meat can be retrieved from the broiler 10. The drawer 30 includes a handle 32 that is configured to be gripped to pull the drawer 30 from below the stack of meat 26 such that the sliced meat can be removed from the tray 34 or the tray 34 with the sliced meat can be replaced with an empty tray 34 such that the cooking and cutting process can automatically continue.

The back wall 22 includes a plurality of rows of slots 23 that allow air to be pulled into the chamber 12 while the stacked meat 26 is cooked with radiant heat. The air flows past the heating elements and the stack of meat 26 to broil the outer layer. The heated air is then exhausted through slots 17 in the top wall 16 and though an opening 25 at the top of the hinged door 24. The cooking of the stack of meat 26 with the vertical broiling elements creates a natural draft or chimney effect that pulls air into the chamber 12 though the plurality of rows of slots 23 in the back wall 22, past the stack of meat 26 and exhausts the air through the slots 17 in the top wall 16 and the opening 25 proximate the top of the hinged door 24. It is noted that the temperature in the chamber 12 is sufficiently high that juices that are generated through the broiling process and fall into the tray 34 are cooked to sufficient temperatures to destroy food borne pathogens. In some embodiments, the broiler 10 can be positioned under a vent to direct particles out of the premise.

The automated vertical broiler 10 includes an on/off switch 36 located on the back wall 22 and a control panel 38 in a front panel 40, where the control panel 38 is configured to monitor the conditions within the chamber 12 and provides controls to manipulate the components with the automated vertical broiler 10. The control panel 38 is typically a touch screen controller. However, other controllers are also within the scope of the present disclosure including, but not limited, an application that can be downloaded onto a mobile electronic device or a computer.

The automated vertical broiler 10 includes a plurality of spaced apart legs 41 extending from the bottom wall 14 proximate the corners of the bottom wall 14. The legs 41 typically include vertically adjustable feet 42 that are used to level the automated vertical broiler 10, where the adjustable feet can be constructed of a low thermally conductive material that minimizes heat transfer from the broiler 10 to the supporting surface.

Referring to FIGS. 1-3, the automated vertical broiler 10 also includes an access panel 44 in the right wall 20 that allows for access to electronics 46 and a cutting mechanism actuator 210 and linear bearing 220 of a cutting mechanism 200. However, the access panel 44 is optional and access could be gained to the electronics 46 and the cutting mechanism actuator 210 and the linear bearing 220 by removing the covering on the right wall 20.

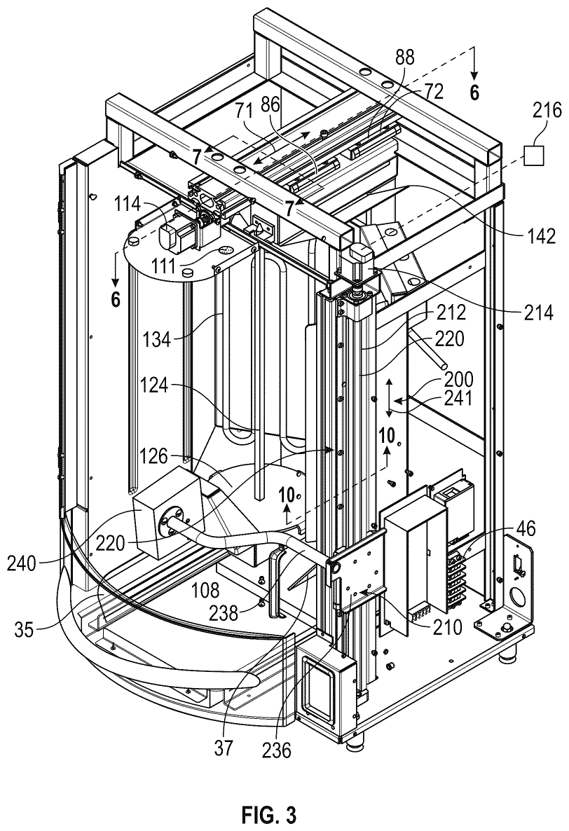

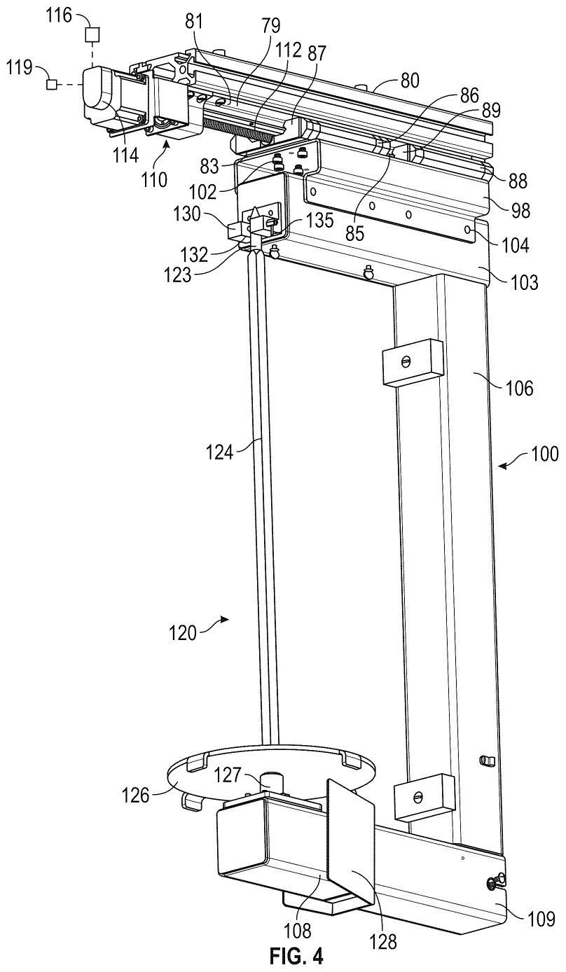

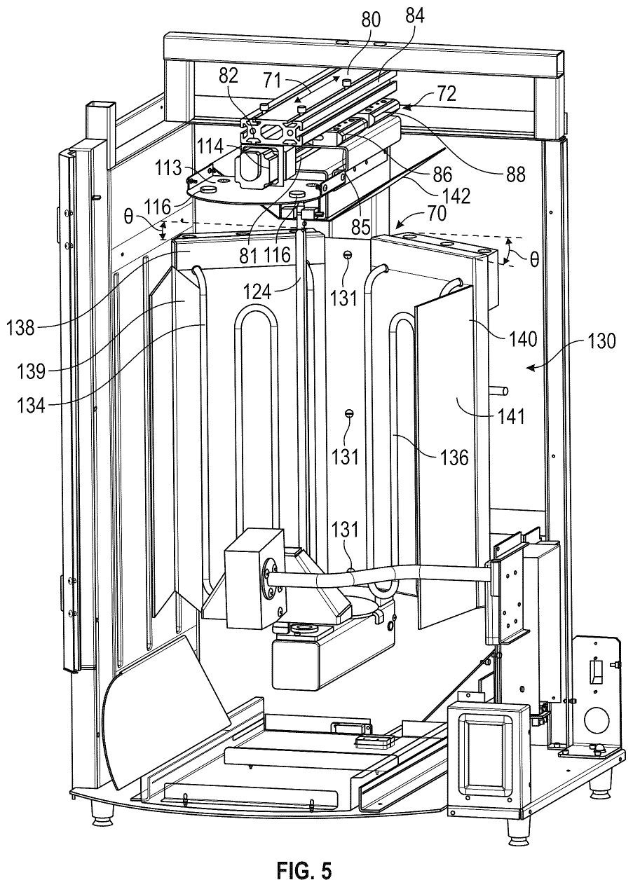

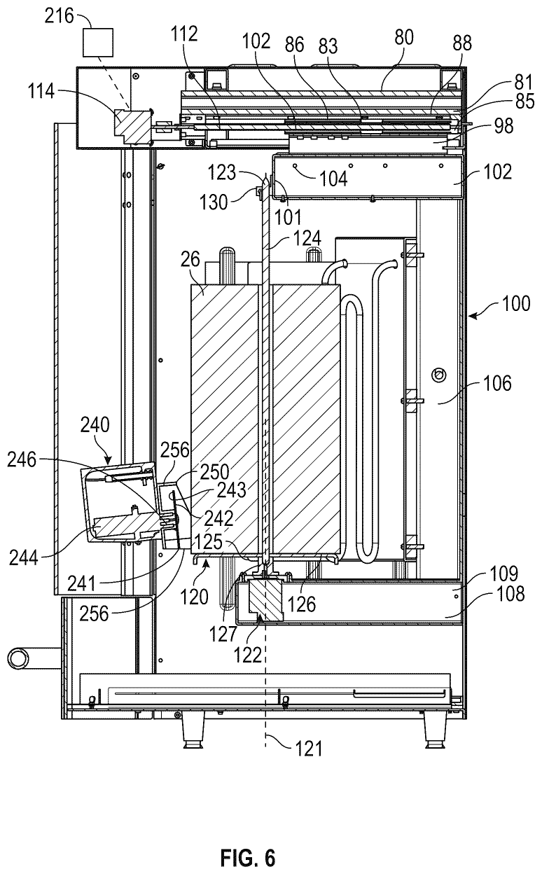

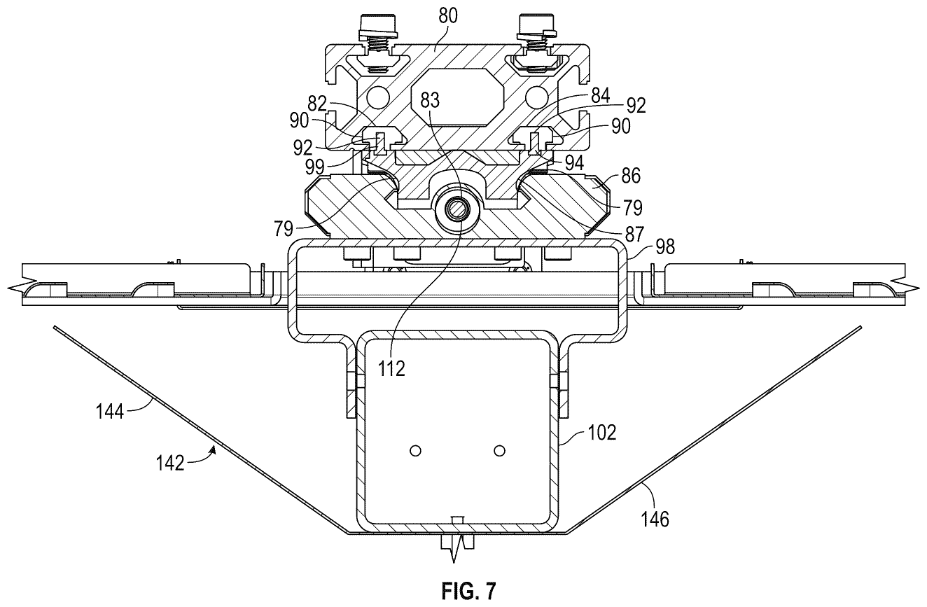

Referring to FIGS. 3-7, the automated broiler 10 includes a broiling structure 70 that moves horizontally in the direction of arrows 71 along a linear bearing 72 securely attached to a substantially horizontal beam 80. A first portion 81 of the linear bearing 72 is secured to the beam 72 by placing nuts 90 have threaded bores 92 into spaced apart channels 82 and 84 and threadably securing the first portion 81 to the beam 80 with bolts 94.

The first portion 81 has side profiles 79 with side channels that slidably accept second portion slides 86 and 88 with complimentary side profiles 87. The side profiles 79 and 87 allow the slides 86 and 88 to move in the direction of the arrow 71 while minimizing or substantially eliminating unwanted movement such as vertically, orthogonal to the arrow, twisting or pivoting.

A mounting bracket 98 is secured to the slides 86 and 88 with bolts 99 and a top member 102 of a substantially “C’ shaped structure 100 is secured to the mounting bracket 98 with bolts 104 secured through apertures in the mounting bracket 98 and threaded bores in side walls of the top member 102. A vertical member 106 is secured to the top member 102 proximate a back end 103, typically with a weld and a bottom member 108 is secured to the vertical member 106 proximate a back end 109, typically with a weld to form the substantially “C” shaped structure 100. The top member 102, the vertical member 106 and the bottom member 108 are constructed of a tubular metal material, such as stainless steel, that are within commercial cooking appliance codes while being able to withstand the twisting and torque created by a spinning cylinder of stacked meat on a skewer.

The broiling structure 70 is moved in the direction of arrows 71 using a linear actuator 110 that includes a threaded rod 112 that threadably engages threaded bores 83 and 85 within the slides 82 and 84. The threaded rod 112 is coupled to an electric motor 114 supported by a mounting plate 113 attached to the beam 80 and encased by a cover 115 (as illustrated in FIG. 1). The mounting plate 113 and the cover 115 substantially prevent spatter caused by the cooking process from engaging and adversely affecting the performance of the electric motor 114. The mounting plate 113 and the cover 115 also aid in preventing heat from adversely affecting the performance of the electric motor 114. Rotation of the electric motor 114 turns the threaded rod 112, which engages the threaded bores 83 and 85 and causes the slides 86 and 88 and the substantially “C” shaped structure 100 to move along the beam 80 in the direction of arrows 71. Knowing the pitch of the threads and rotations of the rod 112 allows the location of the substantially “C’ shaped structure to be known in the horizontal position.

The mounting plate 113 supports lights 111 that are energized to illuminate the chamber 12 such that diners or cooks can view the cooking process through the glass door 24. While the lights 111 are disclosed and illustrated, the lights 111 are not necessary to utilize the broiler 10.

Typically, an encoder 116 monitoring the rotation of the electric motor 114 is used to determine the number of rotations of the rod 112. However, other sensing devices are within the scope of the present disclosure.

The broiling structure 70 includes a rotating spit 120 with an electric motor 122 located with the tubular space within the bottom member 108. The electric motor 122 is coupled to a receptacle 127 that is external to the bottom member 108, such that the bottom member 108 protects the electric motor 122 from becoming caked in spatter from the cooking process. Additionally, the tubular space within the bottom member 108 provides a conduit for the wires for power and control of the electric motor 122, such that the wires are protected as the broiling structure 70 moves in the horizontal direction in the direction of arrows 71. An optional heat shield 128 is removably positioned on the bottom member 108 between the electric motor 122 and the heat source to protect the electric motor 122 from encountering excessive heat and thereby extending the useful life of the electric motor 122.

The stack of meat 26 is positioned over a skewer or spigot 124 where a plate 126 is non-rotatably secured to the skewer or spigot 124 proximate a bottom end 125 and provides support to the stack of meat. Once the stack of meat is secured to the skewer or spigot 124, the bottom end 125 of the skewer or spigot 124 is positioned in the receptacle 127 and a top end 123 is retained in a bracket 130 located at a front end 101 of the top member 102. The bracket 130 has a channel 132 that receives the top end 123 of the skewer or spigot 124 and the top end 123 is retained within the channel with a latch 135 that is movable from a first, unlatched position that allows the top end 123 can be positioned in the channel 132 to a second, latched position that causes the latch 135 to span the channel 132 and retain the top end 123 of the skewer or spigot 124 within the bracket 130. With the bottom end 125 non-rotatably secured within the receptacle 124 and the top end 123 rotatably secured within the bracket 130, the skewer or spigot 124 is substantially vertical.

The top member 102 and the bottom member 108 are substantially horizontal where the top member 102 is shorter than the bottom member 108. With a shorter top member 102, the mounting bracket 130 with the latch 135 can be located on the front end 101 of the top member 102 which makes accessing the latch 135 and positioning an uncooked stack of meat on the skewer or spigot 124 into position readily available. Similarly, once the cooked meat is cut from the skewer or spigot 124, the latch 135 is moved to the second, unlatched position such that the skewer or spigot 124 can be removed from the bracket 130 and the receptacle 127.

A vertical cooking unit 130 is attached to the vertical member 106 with a plurality of threaded bolts 131. The threaded attachment allows the vertical cooking unit 130 to be removed from the broiling structure 70, repaired and or replaced through manipulation of the bolts 131.

The vertical cooking unit 130 includes left and right heating elements 134 and 136 that are supported by left and right heat reflecting panels 138 and 140. The heating elements 134 and 136 and the heat reflecting panels 138 and 140 are at an angle O that positions the heating elements 134 and 136 at an approximation of a radius of a theoretical cylinder of stacked meat such that the stacked meat 26 is substantially evenly heated as the stacked meat rotates past the heating elements 134 and 136. Additional reflecting panels 139 and 141 extend from the reflecting panels 138 and 140 at an angle to aid in directing heat into more surface area of the stack of meat. The heat reflecting panels 138-141 redirect heat energy emitted from the heating elements 134 and 136 toward the stacked meat that would otherwise travel away from the stacked meat 26 to increase the efficiency of the heating elements 134 and 136 while speeding up the cooking process about the perimeter of the stacked meat.

The heating elements 134 and 136 are typically electric resistance heaters. However, other heaters are within the scope of the present disclosure, including but not limited to natural gas or propane powered burners.

The broiling structure includes a heat shield 142 that is attached to the top member 102 and extends substantially along the length thereof. The heat shield142 includes upwardly angled left and right portions 144 and 146 that divert heats from the linear bearing 72 and the linear actuator 110, which aids in maintaining the useful life of the linear bearing.

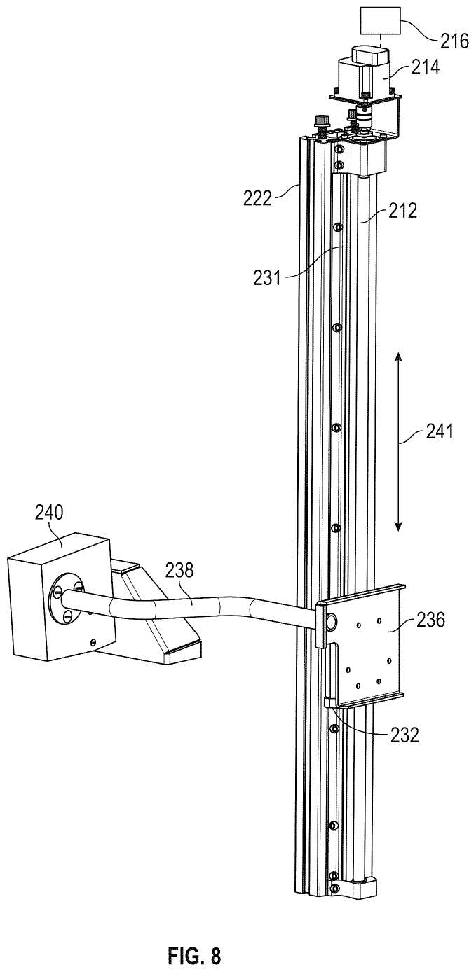

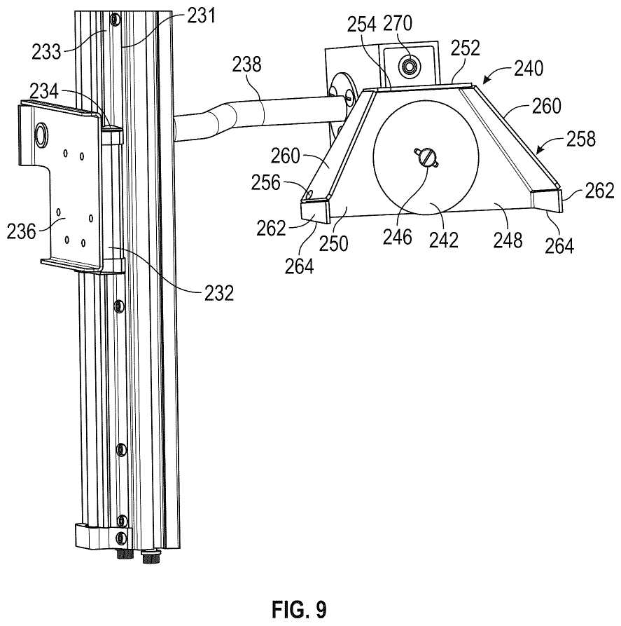

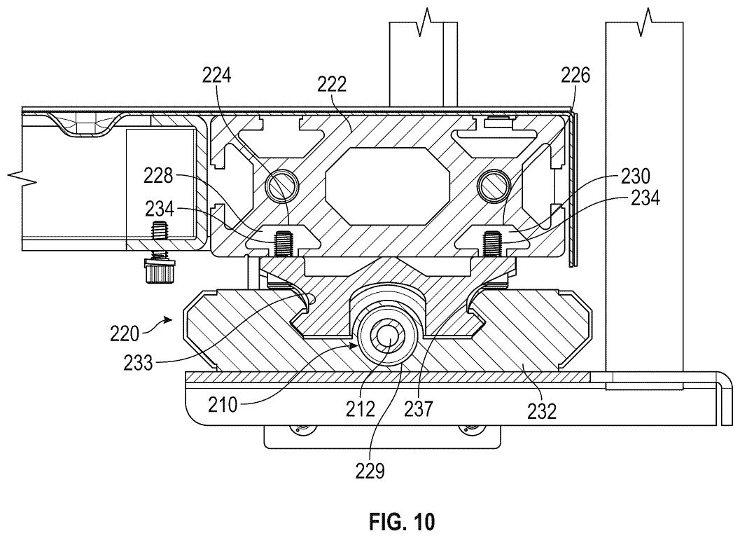

Referring to FIGS. 3, 4 and 8-10, the cutting mechanism 200 of the vertical broiler 10 includes the cutting mechanism actuator 210 and the linear bearing 220. The linear bearing 220 is similar to the linear bearing 72 for the broiler structure 70 and includes a substantially vertical beam 222 with spaced apart channels 224 and 226 that accept nuts 228 and 230 with a complementary configuration such that a first portion 231 of the linear bearing 220 is secured to the beam 22 with bolts 234 such that the first portion 231 is fixed retained to the beam 222. The first portion 231 include side profiles 233 with channels that engage complementary side profiles 237 of a second portion slide 232. The engagement of the side profiles 231 and 237 allow the slide 232 to move vertically in the direction of arrow 241 while substantially preventing horizontal movement or a twisting motion.

A mounting plate 236 is secured to the slide 232 where an arm 238 extends from the plate 236 and toward the stacked meat. A cutting mechanism 240 is attached to the arm 238 where the cutting mechanism includes a circular blade 242 that is powered by an electric motor 244. A shaft 246 from the motor 244 is positioned through an aperture in a shield 248 where the circular blade 242 is non-rotatably secured to the shaft 246 such that the blade 242 rotates with the shaft 246. The shaft 246 is angled upwardly from horizontal such that the blade 242 is angled from vertical where as the blade 242 a bottom region 241 extends closer to the skewer or spigot 124 than an upper region 243. As the blade 242 is lowered onto the stack of meat and cuts the meat into slices from the perimeter, the lower region 241 engages and cuts the meat and having the blade 242 at the angle from vertical provides better access to the meat stack relative to a vertical blade.

The shield 248 is designed to restrict the discharge of spatter from the meat stack 26 during the cutting process. The shield 248 includes a back wall 250 that substantially prevents spatter from hitting the glass door 24 and causing a buildup of grease and grime on the door 24. A top wall 252 extends from the back wall 250 where the length of the top wall 252 is substantially the same as the diameter of the rotating blade 242 and a front edge 254 is substantially even with the upper region 243 of the rotating blade 242. The shield 248 includes left and right sidewalls 256 and 258 that extend from the back wall 250 and are mirror images of each other. Each sidewall 256 and 258 includes a downwardly sloped portion 260 that increases in width from the top wall 252 to substantially vertical portions 262 that terminate at a bottom edge 264 of the shield.

The distance between the vertical portions 262 allows the blade 242 to cut slices of meat from the perimeter of the meat stack while the shield prevents the spreading of spatter during the cutting process. Additionally, the size of the shield is designed for an estimated maximum diameter of the meat stack such that the shield extends proximate the perimeter of the meat stack, which again prevents the spread of spatter during the cutting process.

The cutting mechanism 240 is moved vertically with the linear actuator 210 that includes a threaded rod 212 that threadably engages a threaded through bore 229 in the slide 232. The threaded rod 212 is rotated by an electric motor 214. Knowing the thread pitch of the threaded rod 212 and the number of rotations, typically sensed by an encoder 216 on the electric motor 214 allows the location of the blade 242 to be known in the vertical direction. Knowing the vertical location of the blade 242 allows the maximum amount of meat to be cut from the stack 26 without the blade 242 engaging the plate 126 on the skewer or spigot 124, which prevents the premature dulling of the blade 242. Alternatively, the plate 126 can carry a hygienic material that is substantially softer than metal and does not dull the blade such that the meat can be cut from the entire length of the stack.

The cutting mechanism 240 also carries a non-contact temperature sensor 270 that monitors the surface temperature of the perimeter of the meat stack as the meat stack is rotated on the skewer. The temperature sensor 270 is located above the shield 248 substantially prevents spatter from interfering with the performance of the temperature sensor. An exemplary, non-limiting temperature sensor is an infrared temperature sensor 270. However, other sensors are within the scope of the present disclosure. Additionally, the temperature sensor 270 can be located in different locations within the chamber 12 provided the temperature sensor 270 has clear access to sense the rotating meat stack.

### Controlled Access to Cooking Process Conditions

As the cooking process in the vertical broiler 10 is substantially automated, the control scheme includes levels of authentication based upon the effects that changes in control parameters could have to the automated broiling and slicing process. By way of non-limiting example, three levels of authentication are included in the control scheme including employee, owner or maintenance levels are within the scope of the present disclosure.

By way of example, an employee may have a lowest level of authentication that allows the broiler 10 to be turned on or to select the type of meat being cooked. In contrast, the manager or owner of the dining establishment may have authentication to change the parameters set for the employee along with the temperature setpoint that is required to be read at the surface of the meat stack to ensure the sliced meat is properly cooked and the height of the stack of meat on the skewer or spigot. The maintenance authentication level provides the greatest ability to modify process conditions to a repair technician including those of the employee and owner and/or perform repairs to the broiler where the repair technician level is reserved for employees of the manufacturer or independent technicians that are trained by the manufacturer. By way of example, the maintenance level authentication allows for the recalibration of the control scheme, the replacement of parts and/or adjusting upper and lower limits within the controls scheme. The control scheme can include other levels of authentication as needed to run the automatic broiler efficiently and safely.

The control scheme can be utilized through a graphic user interface on the control panel. Additionally, the control scheme can also be utilized with a wireless connection where an app on a hand held electronic device or a program on a computer can be utilized to provide authentication and then to manipulate process parameters from a location remote from the broiler.

### The Beginning of the Automated Cooking Process

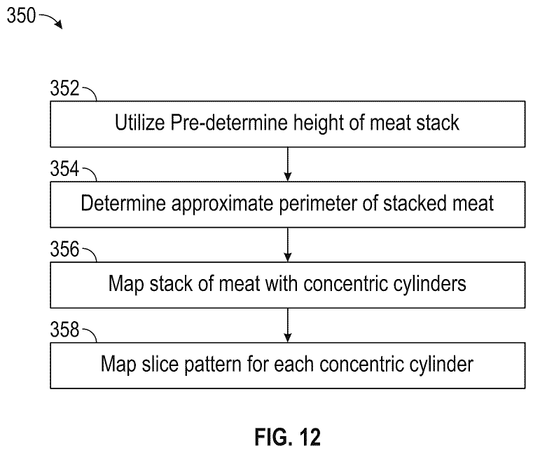

The beginning of the cooking process is illustrated in method 300 as illustrated in FIG. 12. The method 300 includes the step 302 of stacking raw meat 26 on the skewer or spigot 124, positioning the bottom end 125 of the skewer or spigot 124 is positioned in the receptacle 127 and securing the top end 123 of the skewer 12 within the channel 132 of the bracket 130 with the 264.

With the skewer or spigot 124 in position for cooking, at step 304 the electric motor 122 is energized to cause the skewer or spigot 124 and the stack of meat 26 to rotate about an axis 121 of the skewer or spigot 124. At step 306, the heating elements 134 and 136 are then energized which causes heat energy to be directed towards the stack of meat 26. The generated heat causes a draft or chimney effect which draws fresh air into the chamber 12 through the rows of slots 23 in the back wall 22, past the heating elements 134 and 136 and the stack of meat 26 to broil the outer portion of the stack of meat over time and exhausts the heated air through the exhaust slots 17 in the top wall 16 and the openings 25 proximate the top of the door 24. In some embodiments, the exhaust from the broiler is vented from the premise.

As the stack of meat 26 is rotating and the heating elements 134 and 136 are directing energy into the perimeter of the stack of meat 26, the temperature sensor 270 monitors the surface temperature of the stack of meat at step 308. The stack of meat 26, due the meat pieces' non-uniform nature, can have voids which can affect the sensed surface temperature. As such, a running average of the surface temperature is monitored in the control system until the running average reaches or exceeds a temperature setpoint that is known to cook the meat to a safe temperature at step 308. By way of non-limiting example, when about 85% of the sensed surface temperature is at or above the setpoint, the control program determines that the meat stack 26 is cooked to a safe thickness about the perimeter. The cooking process is stopped at step 312 once the perimeter of the meat is determined to reach the preselected average temperature.

While a running average is disclosed and preferred, other methods of determining the surface temperature are within the scope of the present disclosure, including but not limited, determining one or more spot temperatures and/or requiring an uninterrupted series of temperatures that are at or above the setpoint.

### The Automated Mapping Process

Once the control program determines that the meat stack 26 is cooked to a selected depth about the perimeter, the mapping process is initiated in the method 350 as illustrated in FIG. 12. The height of the stack of meat 26 is pre-determined at step 352 by a person have authorization to set the height of the stack of meat.

With the height of the meat stack is pre-determined in step 352, the approximate perimeter of the meat stack in a horizontal plane is determined at step 354. To determine the approximate perimeter of the meat stack 26 due to the non-uniform pieces of meat on the skewer or spigot 124, the broiler mechanism 70 is moved in the horizontal direction until the meat stack 26 contacts the cutting mechanism 240. Once the meat stack 26 contacts the cutting mechanism 240, the electric motor 114 on the linear actuator 110 experiences resistance which causes the amperes drawn by the motor 114 to increase. The rise in amperes is monitored by an ammeter 119, which causes the motor 114 to stop driving the broiler mechanism 70 into the meat stack 26. The location of the perimeter at the contact point is determined by knowing the horizontal position of the broiler mechanism 70 and knowing the horizontal position of the cutting device 240. The location of the point on the perimeter of the meat stack 26 is then recorded in memory.

Thereafter the broiler device 70 is moved away from the cutting mechanism 240 and the skewer or spigot 124 is rotated a selected number of degrees, such as but not limited to 45 degrees by the electric motor 122. After rotating the stack of meat 26 the selected number of degrees, the motor 114 is activated to move the broiler mechanism 70 toward the cutting mechanism 240 until contact is sensed by the rise in amperes drawn by the motor 114 by the ammeter and that horizontal position of the contact point on the perimeter is then recorded in memory.

The process of moving the stack of meat 26 away from the cutting mechanism 240, rotating the stack of meat 26 the selected number of degrees and moving the broiler mechanism 70 toward the cutting mechanism until contact is made between the stack of meat 26 and the cutting mechanism 240 is repeated until an approximation of a cylindrical perimeter of the stack of meat 26 is ascertained. A non-limiting example of the number of substantially uniform contact points is eight that are spaced about forty-five degrees apart. However, it is within the scope of the present disclosure that less than eight contact points or more than eight contact points are used to ascertain an approximation of the cylindrical perimeter.

Once approximation of the cylindrical perimeter is ascertained, the stack of meat is mapped with concentric cylinders that reduce in radius a thickness of a slice of meat at step 356. The concentric cylinders are mapped and reduce in radius until the smallest concentric cylinder is proximate, but spaced a distance from the skewer or spigot 124 such that the blade 242 does not contact the metal skewer or spigot 124, which could damage or dull the blade 242. The vertical broiler also includes a positive stop that limits the movement of the broiler mechanism 70, such that the blade 242 cannot contact the skewer or spigot 124 when in use.

With the vertical position of the cutting device 240 above the meat stack 26 being predetermined and the vertical position of the plate 126 known, the vertical length of the cutting stroke is known. Additionally, knowing the width of the slice determined by the configuration of the blade 242 and the mapped perimeter of the concentric cylinders allows the cutting pattern for each of the mapped layers in the meat stack 26 can be mapped at step 358. By way of example, due to the geometry of the blade 242 and the change in the diameter of the mapped concentric cylinders, the blade 244 will cut wider slices of meat from the perimeter of the larger concentric cylinders and narrower slices of meat from the smaller concentric cylinders. The control logic maps the number of slices that will be cut from each concentric cylinder while substantially maintain the cylindrical configuration for the next layer of meat to be sliced.

### The Automated Slicing Process

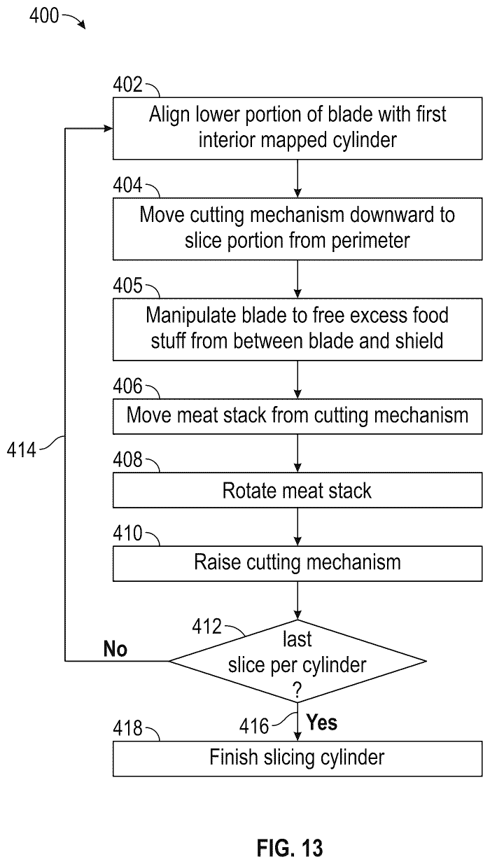

With the outer layer of the stack of meat 26 determined to be cooked to the selected temperature, the concentric cylinders mapped on the stack of meat 26 and the cutting height and pattern for each of the concentric cylinders determined the first layer of meat can be sliced from the stack of meat 26 as disclosed in method 400 as illustrated in FIG. 13. At step 402, the cutting device 240 is raised above the stack of meat 26 and the broiler device 70 is moved in the horizontal position such that the lower region 241 of the blade 242 aligns with a first interior mapped cylinder which is a predetermined slice thickness from the approximated cylindrical perimeter of the stacked meat 26.

The cutting blade 242 is actuated with the motor 244 to a predetermined rotational speed. The cutting device 240 is then lowered along the linear bearing 220 with the linear actuator 210 by activating the where the location of the cutting mechanism 240 is known based upon the thread pitch on the threaded rod 212 and the sensed rotation of the motor 214 by the encoder 216 such that the cutting blade 242 move the length of the determined cutting stroke at step 404. As the slice meat is cut from the stack of meat 26, the slice falls into the tray 34 that is carried by the drawer 30.

Once the cutting blade 242 travels to the bottom of the cutting stroke, the cutting mechanism actuator 210 pauses the movement of the cutting blade 242 while the cutting blade 242 continues to spin at step 405. The spinning action of the cutting blade 242 clears excess chicken from between the cutting blade 242 and the shield 248 prior to cutting the next strip from the stack of meat. The spinning step aids in preventing the cutting blade 242 from becoming jammed, which can adversely affect the performance of the broiler 10.

Once the first slice is cut from the stack, the electric motor 114 is activated such that the broiler device 70 moves away from the cutting device 240 at step 406 to provide clearance between the stacked meat 26 and the cutting device 240. The motor 122 is activated to rotate the skewer or spigot 124 and the stack of meat 26 a selected number of degrees based upon the mapped slices for the layer at step 408 and the cutting device is then raised to the known vertical location above the stack of meat 26 at step 410. A determination is made whether a last slice has been cut from the perimeter at step 412. If the answer is no, at step 414, the steps 402-410 are repeated. Once the answer is yes at 416 the method stops attempting to slice meat from the cylinder at step 418.

### Automatically Cooking and Cutting Additional Layers

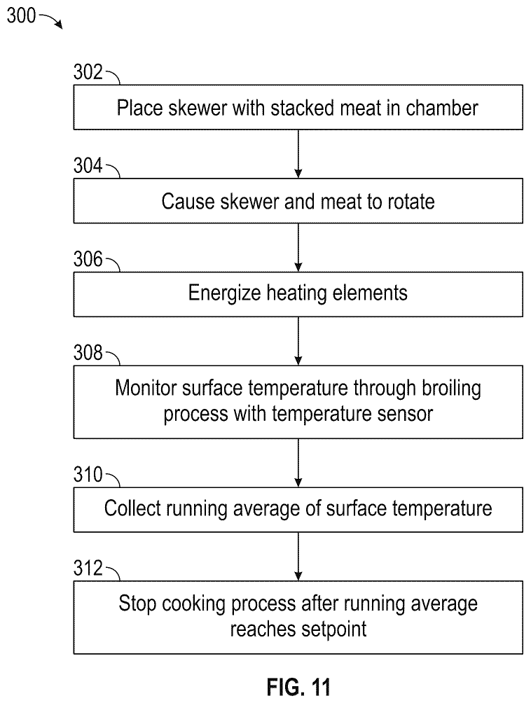

Once the first layer is sliced from the perimeter of the stack of meat 26, the motor 244 causes the skewer 242 and the stack of meat 26 to rotate past the cooking elements 134 and 136 where heated air imparts heat energy into the outer surface of the stack of meat 26 and begins the broiling process for the next layer on the surface of the stack of meat 26. As the stack of meat 26 rotates past the cutting mechanism 240, the temperature sensor 270 monitors the surface temperature until the temperature setpoint is reached on the above disclosed rolling average as illustrated in the method 300 in FIG. 11.

It is noted that the configuration of the stack of meat 26 become closer to a true cylinder as more layers are cut from the stack 26 and the thickness of the slices becomes more uniform due to less variation in the stack 26 the closer the surface is to skewer or spigot 124. Additionally, it has been found that the stack is denser and has less voids the closer the perimeter is to the skewer or spigot 124, such that there is less variation in the sensed temperature.

Once the temperature setpoint is reached, the cutting mechanism 240 is raised in the vertical direction to the known location above the stack of meat 26. The broiler mechanism 70 is moved horizontally such that the next interior mapped cylinder is aligned with the lower portion 241 of the blade 242. At that time the blade 242 is actuated and the cutting process resumes until the next layer of meat is cut into strips and deposited into the tray 34 carried by the drawer 30. The automated cooking and cutting process is continued until the last mapped cylinder is cut from the stack of meat 26. In some embodiments, the power from the heating elements 134 and 136 can be controlled and reduced as the diameter of the stack of meat 26 is reduced during the automated cooking and slicing process as illustrated in the method 400 in FIG. 13.

### Automated Temperature Control Based Upon Anticipated Demand

The control scheme of the automated vertical broiler 10 allows the temperature within the chamber 12 to be adjusted based upon the time of day. Based upon experience, restaurants typically experience surges in diners during the lunch and dinner hours. During the lunch and dinner hours, the automated vertical broiler 10 is controlled to match output to the estimated demand.

However, during less busy times, the control scheme can reduce the heat output to keep the outer layer of the stack of meat 10 warm without having to slice the meat from the stack 26. The warming feature extends the life of the meat on the stack 26, which in turn can increase the restaurant owner's profits.

Additionally, if there is virtually no diner traffic, the control scheme can pause the cooking process until diner traffic resumes, at which time the cooking process is resumed to meet the demand for the sliced meat. Finally, the control scheme can shut down the automated vertical broiler 10 once the demand has stopped for the day.

### Controlled Access to Cooking Process Conditions

As the cooking process in the vertical broiler 10 is substantially automated, the control scheme includes levels of authentication based upon the effects that the changes could have to the automated broiling and slicing process. By way of non-limiting example, three levels of authentication and thereby ability to change process variables in the control scheme including employee, owner or repair technician levels are within the scope of the present disclosure.

By way of example, an employee may have a lowest level of authentication that allows the broiler 10 to be turned on or to select the type of meat being cooked. In contrast, the manager or owner of the dining establishment may only have authentication to change the temperature setpoint that is required to be read at the surface of the meat stack to ensure the sliced meat is properly cooked. The repair technician provides the greatest ability to modify process conditions and/or perform repairs to the broiler where the repair technician level is reserved for employees of the manufacturer or independent technicians that are trained by the manufacturer. The control scheme can include other levels of authentication as needed to run the automatic broiler efficiently and safely.

The control scheme can be utilized through a graphic user interface on the control panel. The control scheme can also be utilized with a wireless connection where an app on a hand held electronic device or a program on a computer can be utilized to provide authentication and then to manipulate process parameters from a location remote from the broiler.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

1. A broiler comprising:
a broiling structure comprising:
a support structure configured to carry heating elements and to accept a skewer of stacked raw meat;
a first linear bearing attached to the support structure and configured to move the support structure in a first linear movement; and
a first linear actuator coupled to the first linear bearing, wherein the first linear actuator is configured to move the support structure along the first linear bearing;
a cutting mechanism comprising:
a cutting component carrying a blade and a non-contact temperature sensor;
a second linear bearing attached to the cutting component and configured to move the cutting component in a second linear movement that is substantially orthogonal to the first linear movement; and
a second linear actuator coupled to the second linear bearing, wherein the second linear actuator is configured to move the cutting component along the second linear bearing; and
a controller configured to:
activate the heating elements, cause the skewer and stacked raw meat to rotate past the heating elements and monitor a surface temperature of the meat during the cooking process such that the cooking process continues until the surface temperature meets or exceeds a setpoint;
cease the cooking process;
cause the stacked meat to be mapped for slicing; and
cause a cooked outer portion of the meat to be cut as slices from the perimeter without the need of human intervention.

2. The broiler of claim 1, wherein the broiler comprises a vertical broiler wherein the skewer includes a substantially vertical axis.

3. The broiler of claim 1, wherein the first and second linear actuators each comprise:
a threaded rod threadably engaging a portion linear bearing;
an electric motor configured to turn the threaded rod and move the portion of the linear bearing; and
a sensor configured to monitor the number of turns of the rod, wherein knowing a thread pitch and the number of turns allows the location of the first portion to be known.

4. The broiler of claim 3, wherein the sensor comprises an encoder configured to monitor the rotations of the electric motor.

5. The broiler of claim 1, wherein the non-contact temperature sensor comprises an infrared temperature sensor.

6. The broiler of claim 1 wherein the cutting component further comprises a shield separating the non-contact temperature sensor from the blade and is configured to prevent spatter from a cutting process by the blade from adversely affecting a performance of the non-contact temperature sensor.

7. The broiler of claim 1, wherein the blade comprises a circular blade and wherein the cutting component carries an electric motor to power the circular blade.

8. The broiler of claim 7, wherein the circular blade is at an angle from the second linear movement of the second linear actuator.

9. The vertical broiler of claim 1, wherein the surface temperature monitoring comprises a running average, where the running average exceeds the setpoint at least about in 85% of the readings.

10. The broiler of claim 1, and further comprising
a skewer drive motor within the support structure; and
a receptacle configured to accept a bottom end of the skewer such that the skewer is non-rotatably retained therein.

11. The broiler of claim 10 and further comprising:
a mounting bracket on the support structure, wherein the mounting bracket is configured to receive and rotatably retain a top end of the skewer such that the skewer is in a selected orientation.

12. The broiler of claim 1 and further comprising a plate non-rotatably attached to the skewer wherein the plate is configured to provide support to the stack of raw meat.

13. The broiler of claim 1 and further comprising a drawer carrying a tray, wherein the tray is configured to receive the slices of meat cut from the stack of meat.

14. The broiler of claim 13 and further comprising a sensor configured to sense the amount of sliced meat in the tray and send a signal to the controller to have the slice meat removed from the tray.

15. The broiler of claim 1 wherein the heating elements comprise electrical resistance heating elements.

16. A method of automatically cooking and slicing meat from a stack of meat in a broiler, the method comprising:
providing the broiler having:
a broiling structure comprising:
a support structure configured to carry heating elements and to accept a skewer of stacked raw meat;
a first linear bearing attached to the support structure and configured to move the support structure in a first linear movement; and
a first linear actuator coupled to the first linear bearing, wherein the first linear actuator is configured to move the support structure along the first linear bearing; and
a cutting mechanism comprising:
a cutting component carrying a blade and a non-contact temperature sensor;
a second linear bearing attached to the cutting component and configured to move the cutting component in a second linear movement that is substantially orthogonal to the first linear movement; and
a second linear actuator coupled to the second linear bearing, wherein the second linear actuator is configured to move the cutting component along the second linear bearing;
placing the skewer with stacked meat into the broiler;
rotating the skewer and stacked meat about an axis of the skewer;
energizing heating elements;
monitor a surface temperature through the heating process with a non-contact temperature sensor in real time; and
stopping the cooking process after the surface temperature reaches or exceeds a predetermined setpoint.

17. The method of claim 16 and further comprising determining a running average of the surface temperature and stopping the cooking process after the running average of the surface temperature reaches or exceeds the predetermined setpoint.

18. The method of claim 16 and further comprising:
determining a height of the stacked meat;
determining an approximate perimeter of the stacked meat;
mapping the stacked meat with concentric cylinders; and
mapping a slice pattern for each of the concentric cylinders.

19. The method of claim 18 and wherein determining the approximate perimeter of the stacked meat comprises:
moving the stacked meat into contact with the cutting component;
determining the location of the contact;
moving the stacked meat away from the cutting component;
rotating the stacked meat a selected number of degrees; and
repeating the moving, determining moving and rotating steps for a selected number of times such that the perimeter can be approximated as a cylinder using the contact points.

20. The method of claim 18 and wherein determining a height of the stacked meet comprises:
locating the cutting component in a known location;
moving the stacked meat into contact with the cutting component;
moving the stacked meat away from the cutting component;
moving the cutting component into another location; and
repeating the moving, moving and raising steps until the cutting component does not contact an upper surface of the stacked meat.

21. The method of claim 16 and further comprising:
aligning the blade with a first interior concentric cylinder from the perimeter;
lowering the cutting component vertically along the mapped first concentric cylinder to cut a slice of cooked meat from the stack;
moving the meat stack horizontally away from the meat stack;
rotating the meat stack a selected number of degrees;
raising the cutting component above the meat stack; and
repeating the aligning, lowering, moving, rotating and raising steps until the meat has been sliced from the stack along the mapped first interior concentric cylinder.

22. The method of claim 19 and further comprising:
rotating the stacked meat about an axis of the skewer;
energizing heating elements;
monitor a surface temperature through the heating process with a non-contact temperature sensor;
collect a running average of the surface temperature; and
stopping the cooking process after the running average surface temperature reaches or exceed a predetermined setpoint;
aligning the blade with a next interior concentric cylinder from the perimeter;
lowering the cutting component vertically along the mapped next concentric cylinder to cut a slice of cooked meat from the stack;
moving the meat stack horizontally away from the meat stack;
rotating the meat stack a selected number of degrees;
raising the cutting component above the meat stack;
repeating the aligning, lowering, moving, rotating and raising steps until the meat has been sliced from the stack along the mapped next interior concentric cylinder; and
repeating the above steps until a last mapped concentric cylinder is sliced from the stack of meat.

23. The method of claim 16, wherein the broiler comprises a vertical broiler.
